(19) United States
(12) Patent Application Publication
(10) Pub. No.: US 2009/0209238 A1
(43) Pub. Date: Aug. 20, 2009

(54) Nametones

(76) Inventors: McClifton Taft Magee, JR., Palmdale, CA (US); McClifton Taft Magee, SR., Huntington Beach, CA (US)

Correspondence Address: LAWRENCE S. COHEN, ESQ.;LAW OFFICE OF LAWRENCE S. COHEN, 10960 WILSHIRE BLVD, SUITE 1220, LOS ANGELES, CA, 90024, US

(21) Appl. No.: 12/396,334

(22) Filed: Mar. 2, 2009

Related U.S. Application Data
(63) Continuation of application No. 11/119,445, filed on May 2, 2005, now abandoned.

(51) Int. Cl. H04M 3/42

(52) U.S. Cl. 455/414.1

(57) ABSTRACT

We professionally record original or published songs and enter someone's name or alias or nickname etc. where a key word or phrase existed before. Editing our recording in such a way that we can insert the name, and accompanying music, of someone so as to personalize the cell phone ringer does this. For example, take the 1960's hit “My Girl” by the Temptations: Instead of “I guess you say, what can make me feel this way . . . “My Girl”; we would replace “My Girl” with “Mary” or “Johnny” or what have you.

### RELATED APPLICATION

This patent is a continuation of and claims priority and the benefit for common subject matter, of U.S. patent application Ser. No. 11/119,445 filed on May 2, 2005 entitled “Nametones” the entire content of which is hereby incorporated by reference as if set forth in its entirety, for all purposes.

### BRIEF DESCRIPTION OF THE DRAWINGS

FIG. 1 is a block diagram of the method of the invention

FIG. 2 is a block diagram of the method of the invention FIG. 3 is a block diagram of the method of the invention

### DESCRIPTION OF THE INVENTION

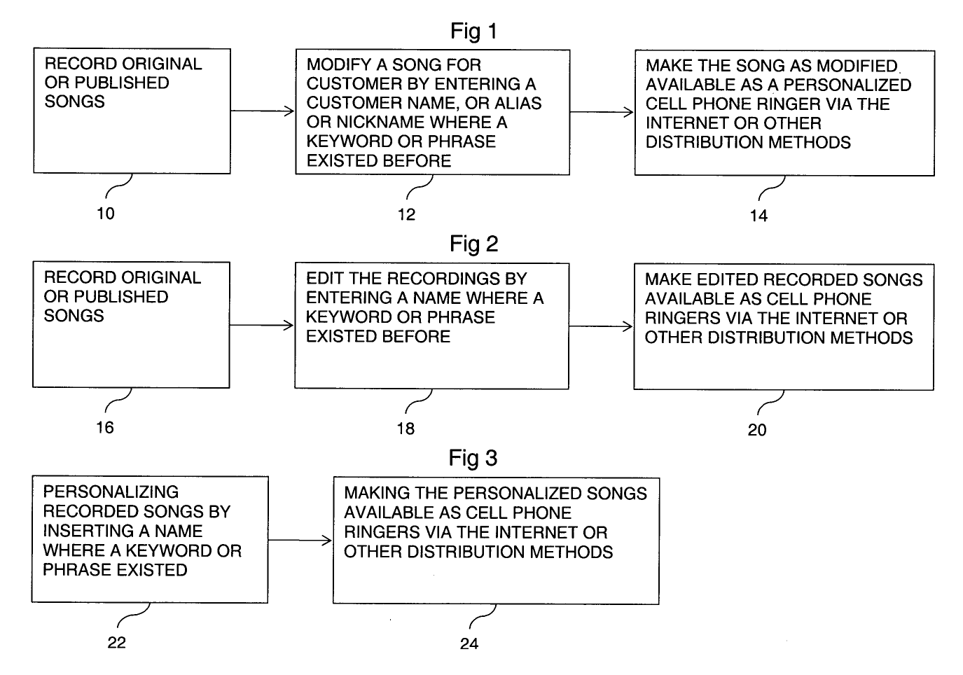

The following description can be read with reference to FIGS. 1, 2 and 3. A name tone is a personalization of the classic ring tone. We record original or published songs 10, 16 and 22 and enter a customer's name or alias or nickname 12, 18 and 22 where a key word or phrase existed before. For example, take the 1960's hit “My Girl” by the Temptations: Instead of “I guess you say, what can make me feel this way . . . “My Girl”; we would replace “My Girl” with “Mary” or “Johnny” or what have you.

These songs are then made available as cell phone ringers via the Internet or other distribution methods 14, 20 and 24.

To implement the invention, we professionally record original or published songs 10, 16 and 22 and enter someone's name or alias or nickname etc. where a key word or phrase existed before 12, 18 and 22. Editing our recording in such a way that we can insert the name, and accompanying music, of someone so as to personalize the cell phone ringer does this. Then the songs are made available as cell phone ringers via the internet or other distribution methods 14, and 24.

FIG. 1 is a block diagram of the invention in which original or published songs are recorded 10; then a song is modified for a customer by entering a customer name, or alias or nickname where a key word or phrase existed before 12 and then the song as modified is made available as a personalized cell phone ringer via the internet or other distribution method 14.

FIG. 2 is a block diagram of the invention in which original or published songs are recorded 16; then the recordings are edited by entering a name where a keyword or phrase existed before 18 and then the edited recorded songs are made available as cell phone ringers via the internet or other distribution methods 20.

FIG. 3 is a block diagram of the invention in which songs are personalized by inserting a name where a keyword or phrase existed 22; and then the personalized songs are made available as cell phone ringers via the internet or other distribution methods 24.

1. A method for the personalizing of songs that will be used as cell phone ringers comprising:
recording original or published songs;
modifying a song by entering a customer's name or alias or nickname where a key word or phrase existed before in the song;
making the song as modified available to the customer as a personalized cell phone ringer on the customer's cell phone via the internet or other distribution methods.

2. A method of providing a personalized cell phone ringer comprising;
recording original songs or published songs;
editing the recordings by entering a name in the songs where a key word or phrase existed before;
making the edited recorded songs available to a customer as cell phone ringers on the customer's cell phone via the internet or other distribution methods.

3. A method of making songs available as personalized cell phone ringers comprising;
personalizing songs;
making the personalized songs available as cell phone ringers via the internet or other distribution methods.
